(19) United States
(12) Patent Application Publication
(10) Pub. No.: US 2014/0240979 A1
(43) Pub. Date: Aug. 28, 2014

(54) LIGHT SOURCE DEVICE

(71) Applicants: WINTEK CORPORATION, TAICHUNG CITY (TW); DONGGUAN MASSTOP LIQUID CRYSTAL DISPLAY CO., LTD., DONGGUAN CITY (CN)

(72) Inventors: Ping-Yeng Chen, Taichung City (TW); Kuo-Jui Huang, Taichung City (TW); Hsiu-Ping Lee, Taichung City (TW); Ming-Chuan Lin, Taichung City (TW)

(73) Assignees: WINTEK CORPORATION, TAICHUNG CITY (TW); DONGGUAN MASSTOP LIQUID CRYSTAL DISPLAY CO., LTD., DONGGUAN CITY (CN)

(21) Appl. No.: 14/190,109

(22) Filed: Feb. 26, 2014

(30) Foreign Application Priority Data
Feb. 27, 2013 (TW) 102203734

(51) Int. Cl. F21V 7/00

(52) U.S. Cl. CPC F21V 7/00
USPC 362/235; 362/296.05

(57) ABSTRACT

A light source device is disclosed and includes a reflective cup, a light-emitting chip, and a light transmissive substrate. The reflective cup has an opening. The light-emitting chip has a light-emitting layer, a first light-emitting surface, and a second light-emitting surface. The first and second light-emitting surfaces are opposite right to a first side and a second side of the light-emitting layer. The light-emitting chip is disposed inside the reflective cup, such that light emitted from the first and second sides emits out of the light-emitting chip through the first and second light-emitting surfaces respectively to be reflected by the reflective cup to be emitted out of the reflective cup through the opening. Therefore, the light extraction efficiency of the light-emitting chip can be improved.

### BACKGROUND OF THE INVENTION

1. Field of the Invention

The invention relates to a light source device, and especially relates to a light source device using a reflective cup.

2. Description of the Prior Art

Most conventional converging lamps use tungsten filaments as lighting sources. Due to tungsten filaments having poor energy conversion efficiency, and shorter service life, some converging lamps which use a light-emitting diode (LED) as a lighting source rather than the tungsten filament are available on the market. Light is generated from a quantum well of the LED. Because the refractive index of the LED chip is usually high, the light emitted from the LED chip is substantially distributed in a lambertian manner. Subsequently, the light emitted from the LED chip is converged by a secondary optical lens. Common packages for LED chips use an opaque substrate so that the LED chip emits light at only single side thereof. Therefore, only about a half of the light can be emitted out of the LED chip leading to energy waste.

### SUMMARY OF THE INVENTION

An objective of the invention is to provide a light source device, which has a light-emitting assembly emitting light from its two opposite sides toward a reflective cup, so that the attenuation of the light is depressed so as to improve the light extraction efficiency of the light source device.

The light source device of the invention includes a reflective cup and at least one light-emitting assembly disposed inside the reflective cup. The reflective cup has an opening. The opening has an opening direction. The light-emitting assembly includes a light transmissive substrate, at least one light-emitting chip, and an electrode circuit. The light-emitting chip includes a first light-emitting surface and a second light-emitting surface. Therein, the first light-emitting surface of the light-emitting chip is mounted on the light transmissive substrate in a flip-chip way. The light-emitting chip provides a first light and a second light. The first light is emitted from the first light-emitting surface. The second light is emitted from the second light-emitting surface. The electrode circuit is disposed on the light transmissive substrate and electrically connected to the light-emitting chip. Thereby, after the first light leaves the first light-emitting surface, the first light passes through the light transmissive substrate and out of the light-emitting assembly to be reflected by the reflective cup to be emitted out of the reflective cup through the opening. The second light is emitted out of the light-emitting assembly in a direction away from the light transmissive substrate to be reflected by the reflective cup to be emitted out of the reflective cup through the opening. Therefore, the times of internal reflection in the light-emitting chip of the light generated from two sides of a light-emitting layer of the light-emitting chip can be reduced, so as to improve the light extraction efficiency of the light-emitting chip. Compared with a case in the prior art that the conventional light-emitting chip is provided with a reflection layer on its bottom for reflecting light, the light-emitting chip of the invention is provided without any reflection layer on its surfaces, so the light generated inside the light-emitting chip is not reflected by the reflection layer and the traveling path of the light inside the light-emitting chip is shorter. Therefore, the attenuation of the light inside the light-emitting chip can be reduced as much as possible, so as further to enhance the light extraction efficiency of the light-emitting chip.

Furthermore, because the two sides of the light-emitting assembly can emit light to the reflective cup, the lighting area of the light-emitting assembly is increased. Moreover, in an embodiment of the present invention, the optical axis of the light-emitting assembly is not parallel to the opening direction of the reflective cup, compared with the light source device in the prior art that the optical axis of the conventional light-emitting assembly emitting light at single side is parallel to the opening direction of its reflective cup, more of the light of the present invention is distributed by the optical structure of the reflective cup, so as to improve the collimation and uniformity of the light provided by the light source device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top view of a light source device of a first embodiment according to the invention.

FIG. 2 is a sectional view of the light source device in FIG. 1 along the line X-X.

FIG. 3 is a schematic diagram illustrating a light-emitting assembly of the light source device in FIG. 1.

FIG. 4 is a top view of a light source device of a second embodiment according to the invention.

FIG. 5 is a sectional view of the light source device in FIG. 4 along the line Y-Y.

FIG. 6 is a top view of a light source device of a third embodiment according to the invention.

FIG. 7 is a top view of a light source device of a fourth embodiment according to the invention.

FIG. 8 is a sectional view of the light source device in FIG. 7 along the line Z-Z.

FIG. 9 is a top view of a light source device of a fifth embodiment according to the invention.

FIG. 10 is a top view of a light source device of sixth embodiment according to the invention.

FIG. 11 is a schematic diagram illustrating a light-emitting assembly of another embodiment according to the invention.

### DETAILED DESCRIPTION

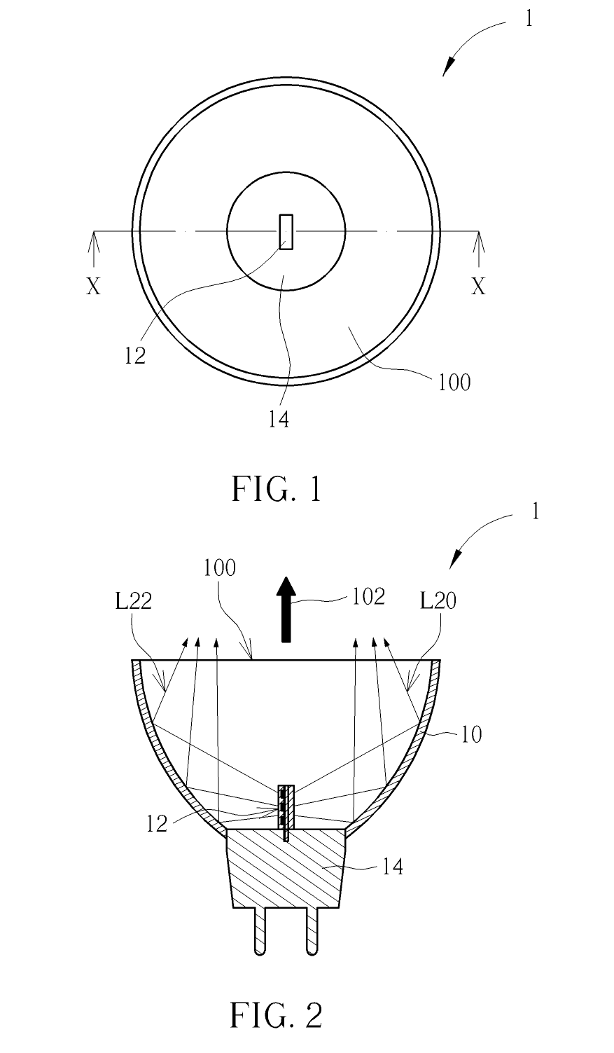

Please refer to FIG. 1 and FIG. 2. FIG. 1 is a top view of a light source device 1 of a first embodiment according to the invention. FIG. 2 is a sectional view of the light source device 1 along the line X-X in FIG. 1. The light source device 1 includes a reflective cup 10, a light-emitting assembly 12, and a connection socket 14. The reflective cup 10 is a cup shaped structure and has an opening 100. The opening 100 has an opening direction 102 (indicated by an arrow in FIG. 2). The connection socket 14 is connected to the bottom of the reflective cup 10. The light-emitting assembly 12 is disposed inside the reflective cup 10 and electrically connected to the connection socket 14. The light-emitting assembly 12 can emit light L20 and L22 from its two opposite sides. The light L20 and L22 are reflected by the reflective cup 10 to travel toward the opening 100. A portion of the light L20 and L22 is emitted out of the light source device 1 substantially in the opening direction 102. In addition, in the embodiment, the connection socket 14 includes a control circuit for driving the light-emitting assembly 12, a heat dissipation structure, and a connection interface for connecting with an external power source, which is well-known by the skilled people in the art and will not be described herein. Furthermore, for simplifying the drawing, the connection socket 14 is illustrated in a single kind of hatched lines in FIG. 2.

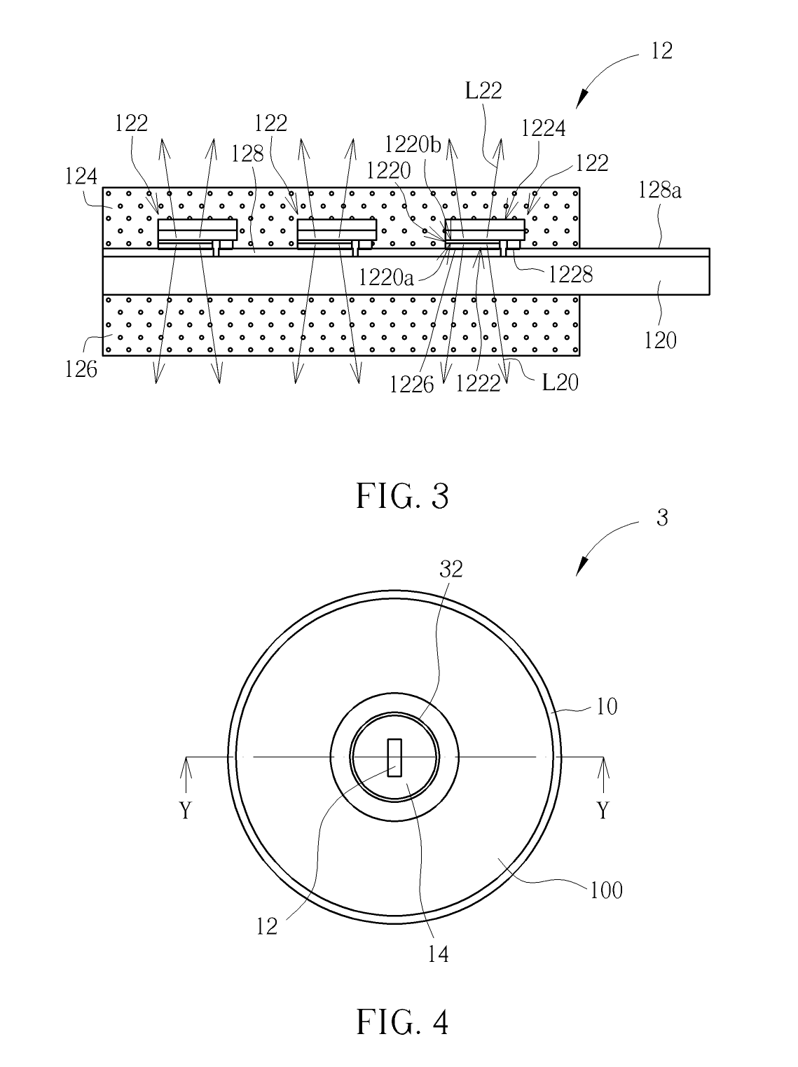

Please also refer to FIG. 3, which is a schematic diagram illustrating the light-emitting assembly 12. For further details, the light-emitting assembly 12 includes a light transmissive substrate 120, a plurality of the light-emitting chip 122, an electrode circuit 128, a first cover layer 124, and a second cover layer 126. The light-emitting chips 122 are disposed on the same side of the light transmissive substrate 120. The light transmissive substrate 120 can be made of silicon carbide (SiC), aluminum oxide, or glass, but the invention is not limited thereto. The electrode circuit 128 is disposed on the light transmissive substrate 120. The electrode circuit 128 can be made of transparent metal oxide (e.g. indium oxide tin), graphene, or other transparent conductive material, so that the electrode circuit 128 can be also transparent; however, the invention is not limited thereto. The light-emitting chip 122 has a light-emitting layer 1220, a first light-emitting surface 1222, and a second light-emitting surface 1224. The light-emitting chip 122 can be a semiconductor light-emitting chip such as a light-emitting diode. The first light-emitting surface 1222 and the second light-emitting surface 1224 are opposite right to a first side 1220a and a second side 1220b of the light-emitting layer 1220 respectively. The light-emitting chip 122 further includes a first electrode 1226 and a second electrode 1228. The light-emitting chip 122 is bound through the first light-emitting surface 1222 onto the light transmissive substrate 120 in a flip-chip way, so that the first electrode 1226 and the second electrode 1228 are electrically connected to the electrode circuit 128. The first cover layer 124 includes color conversion material (such as phosphor powder and so on) and covers the second light-emitting surface 1224 of the light-emitting chip 122 for packaging the light-emitting chip 122 on the light transmissive substrate 120. The second cover layer 126 also includes color conversion material and covers another side of the light transmissive substrate 120 where none of the light-emitting chips 122 is disposed.

It is added that, because the light-emitting chip 122 faces toward the light transmissive substrate 120 and the electrode circuit 128 which may have refractive indices different from the light-emitting chip 122, partial light (i.e. a portion of the light L20) will be reflected on the light transmissive substrate 120 and/or the electrode circuit 128 leading to a ratio difference of the light in the two directions (i.e. the two sides of the light-emitting device 12). For a clear drawing for FIG. 3, the reflected portion of the light L20 is not shown in FIG. 3. Such ratio difference induces a color aberration. For reducing the influence by the color aberration, in some embodiments, the thickness of the first cover layer 124 can be thicker than that of the second cover layer 126.

The first light L20 emitted from the first side 1220a of the light-emitting layer 1220 leaves the light-emitting chip 122 through the first light-emitting surface 1222 and passes through the light transmissive substrate 120 and the second cover layer 126. The second light L22 emitted from the second side 1220b of the light-emitting layer 1220 leaves the light-emitting chip 122 through the second light-emitting surface 1224 and passes through the first cover layer 124. In the embodiment, a portion of the electrode circuit 128 exposed out of the first cover layer 124 can be treated as a terminal 128a for being inserted into the connection socket 14. For example, the terminal 128a is inserted into a corresponding insertion hole disposed at the connection socket 14 for achieving the purpose of electrical connection. When the light-emitting assembly 12 is fixed on the connection socket 14, the first light-emitting surface 1222 and the second light-emitting surface 1224 of the light-emitting chip 122 are parallel to the opening direction 102. After leaving from the light transmissive substrate 120 and the second cover layer 126, the first light L20 is reflected by the reflective cup 10 to be emitted out of the reflective cup 10 through the opening 100; after leaving from the second light-emitting surface 1224 and the first cover layer 124, the second light L22 is reflected by the reflective cup 10 to be emitted out of the reflective cup 10 through the opening 100. In practice, the light distribution pattern formed by the light L20 and L22 emitted out of the reflective cup 10 can be designed by the location of the light-emitting assembly 12 (or the light-emitting chips 122) inside the reflective cup 10 or by the shape of the reflective cup 10.

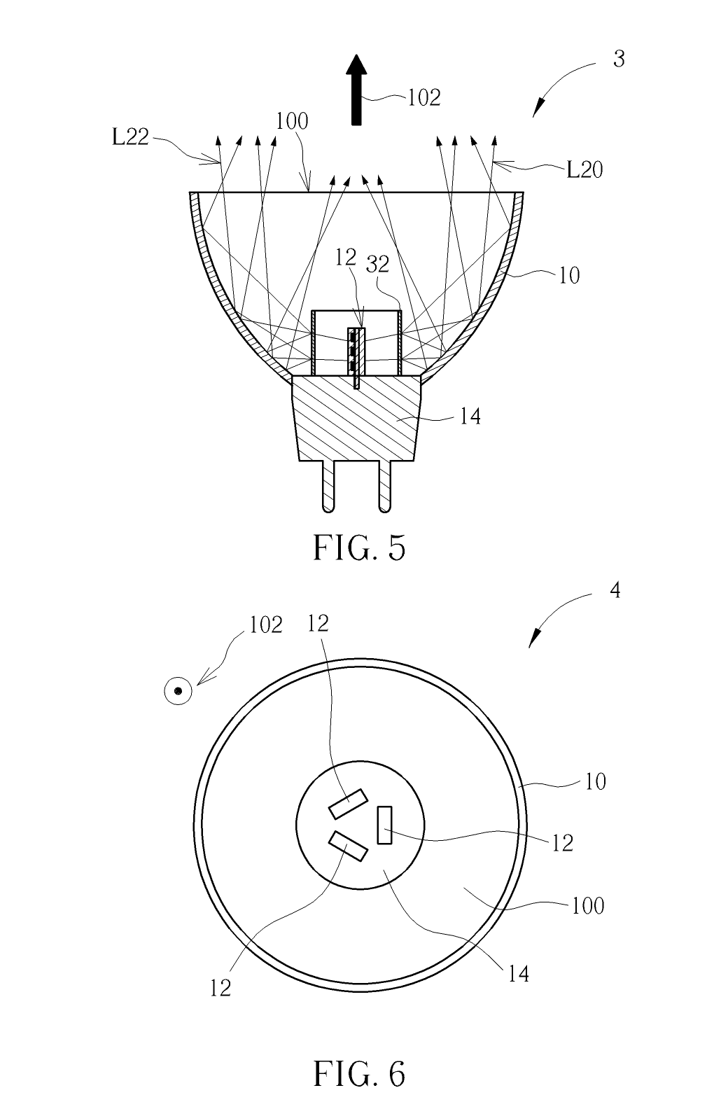

Please refer to FIG. 4 and FIG. 5. FIG. 4 is a top view of a light source device 3 of a second embodiment according to the invention. FIG. 5 is a sectional view of the light source device 3 along the line Y-Y in FIG. 4. The light source device 3 is substantially similar in structure to the light source device 1; therefore, the light source device 3 still uses the component notations for the light source device 1. The main difference between the light source device 3 and the light source device 1 is that the light source device 3 further includes a diffusion cover 32 disposed inside the reflective cup 10 and surrounding the light-emitting assembly 12 (or the light-emitting chips 122) so that after leaving from the light-emitting assembly 12 (or the light-emitting chips 122), the first light L20 and the second light L22 pass through the diffusion cover 32 and are diffused by the diffusion cover 32 to be reflected by the reflective cup 10 to be emitted out of the reflective cup 10 through the opening 100, so as to enhance the light-emitting uniformity of the light source device 1. In the embodiment, the diffusion cover 32 is a barrel-shaped part and can be made by a light transmissive material with optical diffusion particles (e.g. SiO₂) distributed inside or with a surface a diffusion structure formed thereon (e.g. by sandblasting), but the invention is not limited thereto. In addition, in some other different embodiments, the diffusion cover 32 can also include color conversion material. In such case, the light-emitting assembly 12 can be provided without coating with the first cover layer 124 and the second cover layer 126. The haze of the diffusion cover 32 can be designed to be equal to or larger than 90%. The geometric shape of the diffusion cover 32 can be a vaulted structure to cover above the light-emitting assembly 12, but the invention is not limited thereto. For other descriptions of the light source device 3, please refer to the relevant descriptions of the light source device 1, which will not be described in addition.

Please refer to FIG. 6, which is a top view of a light source device 4 of a third embodiment according to the invention. The light source device 4 is substantially similar in structure to the light source device 1; therefor, the light source device 4 still uses the component notations for the light source device 1. The main difference between the light source device 4 and the light source device 1 is that the light source device 4 includes three light-emitting assemblies 12. In the light source device 4, the light-emitting assemblies 12 are arranged in a circular configuration inside the reflective cup 10 and electrically connected to the connection socket 14. The first light-emitting surface 1222 and the second light-emitting surface 1224 of each light-emitting chip 122 are parallel to the opening direction 102 of the reflective cup 10. By arranging light-emitting assemblies 12 in a circular configuration, compared with the light source device 1, the light-emitting symmetry of the light source device 4 can be further improved. In the embodiment, the quantity of the light-emitting assemblies 12 is only three, so after arranged in the circular configuration, the arrangement of the light-emitting assemblies 12 also show a triangular configuration. The more light-emitting assemblies are used. The arrangement of the light-emitting assemblies is more like a circular configuration. Therefore, the light-emitting pattern is more symmetrical, so that the light distribution curve of the light source device according to the invention approaches to the light distribution curve of the conventional tungsten filament lamp. It is added that, in the embodiment, it is unquestionable for an ordinary person in the art to dispose more corresponding insertion holes at the connection socket according to the above description for the light-emitting assemblies 12 to insert into so as to achieve the purpose of the electrical connection between each light-emitting assembly 12 and the connection socket 14. In addition, in practice, the light source device 4 can also include a diffusion cover (e.g. the diffusion cover 32 of the light source device 3) surrounding the light-emitting assemblies 12 so as to enhance the light-emitting uniformity of the light source device 4. For other descriptions of the light source device 4, please refer to the relevant descriptions of the light source device 1, which will not be described in addition.

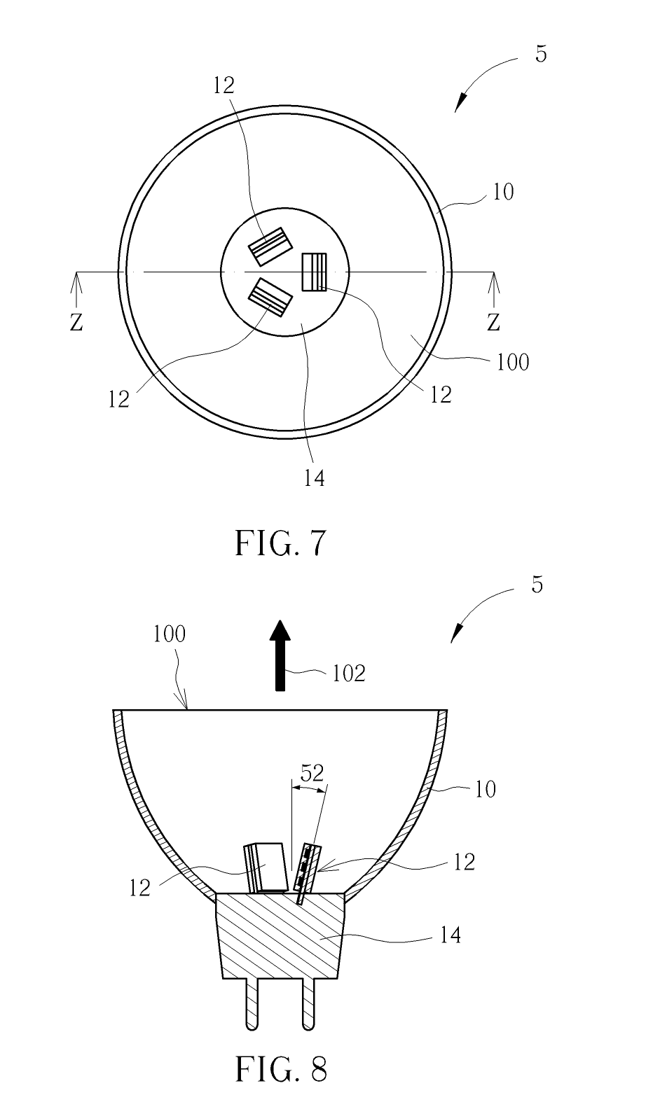

Please refer to FIG. 7 and FIG. 8. FIG. 7 is a top view of a light source device 5 of a fourth embodiment according to the invention. FIG. 8 is a sectional view of the light source device 5 along the line Z-Z in FIG. 7. The light source device 5 is substantially similar in structure to the light source device 4; therefore, the light source device 5 still uses the component notations for the light source device 4. The main difference between the light source device 5 and the light source device 4 is that the three light-emitting assemblies 12 of the light source device 5 are obliquely disposed relative to the opening direction 102; that is, an acute angle 52 is formed between the opening direction 102 and the first light-emitting surface 1222 or the second light-emitting surface 1224 of each light-emitting chip 122. By such oblique configuration, the light emitted from the light source device 5 can be further dispersed, which is conducive to adjustment of the light-emitting uniformity. For other descriptions of the light source device 5, please refer to the relevant descriptions of the light source device 4, which will not be described in addition.

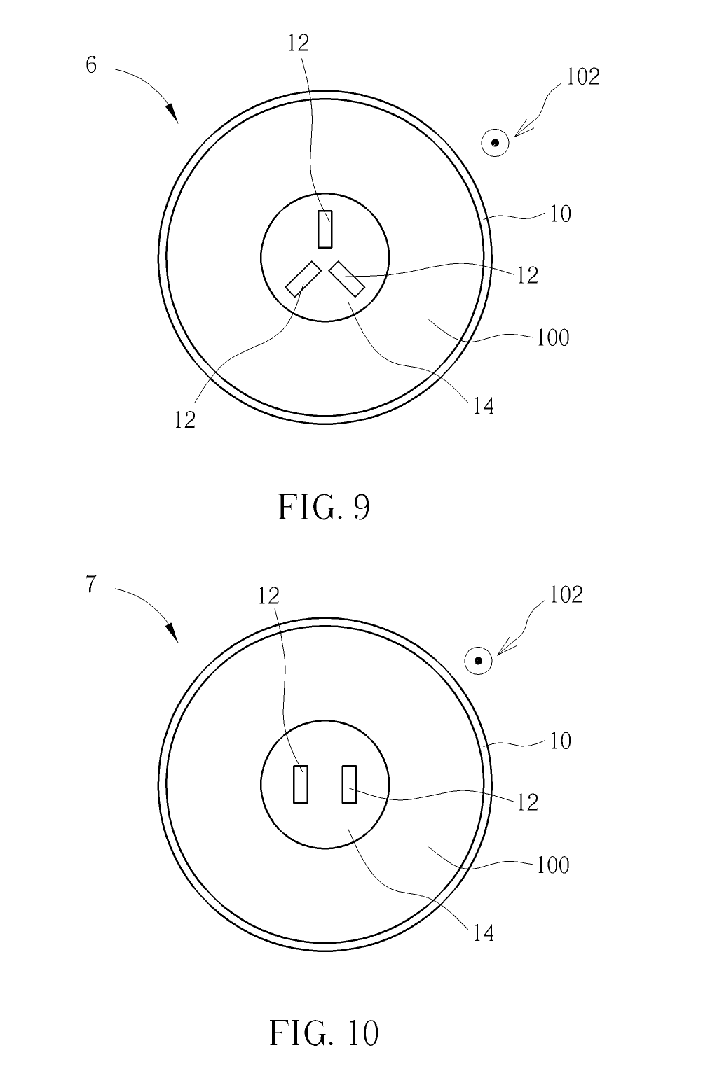

Please refer to FIG. 9, which is a top view of a light source device 6 of a fifth embodiment according to the invention. The light source device 6 is substantially similar in structure to the light source device 4; therefore, the light source device 6 still uses the component notations for the light source device 4. The main difference between the light source device 6 and the light source device 4 is that the three light-emitting assemblies 12 of the light source device 6 are arranged in a radial configuration inside the reflective cup 10. Besides, the first light-emitting surface 1222 and the second light-emitting surface 1224 of each light-emitting chip 122 are parallel to the opening direction 102 of the reflective cup 10. However, in some different embodiments, an acute angle (like the acute angle 52 of the above light source device 5) is formed between the opening direction 102 and the first light-emitting surface 1222 or the second light-emitting surface 1224 of each light-emitting chip 122. For other descriptions of the light source device 6, please refer to the relevant descriptions of the light source device 4, which will not be described in addition.

Please refer to FIG. 10, which is a top view of a light source device 7 of a sixth embodiment according to the invention. The light source device 7 is substantially similar in structure to the light source device 1; therefore, the light source device 7 still uses the component notations for the light source device 1. The main difference between the light source device 7 and the light source device 1 is that the light source device 7 includes two light-emitting assemblies 12 oppositely disposed inside the reflective cup 10. In the embodiment, the first light-emitting surface 1222 and the second light-emitting surface 1224 of each light-emitting chip 122 are parallel to the opening direction 102 of the reflective cup 10. However, in some different embodiments, an acute angle (like the acute angle 52 of the above light source device 5) is formed between the opening direction 102 and the first light-emitting surface 1222 or the second light-emitting surface 1224 of each light-emitting chip 122. In addition, in practice, the light source device 7 can also include a diffusion cover (e.g. the diffusion cover 32 of the light source device 3) surrounding the light-emitting assemblies 12 so as to enhance the light-emitting uniformity of the light source device 7. For other descriptions of the light source device 7, please refer to the relevant descriptions of the light source device 1, which will not be described in addition.

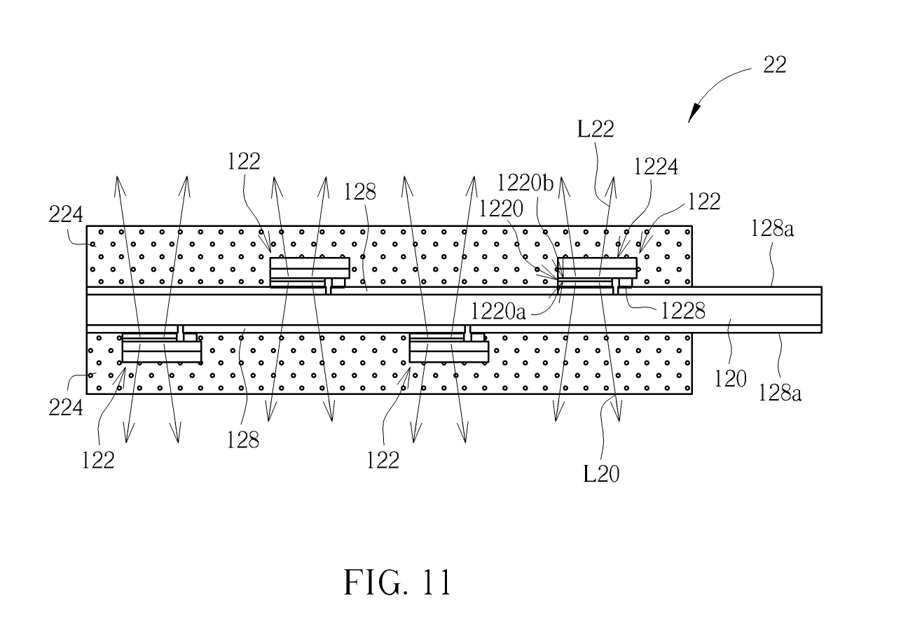

Please refer to FIG. 11, which is a schematic diagram illustrating a light-emitting assembly 22 of another embodiment according to the invention. The light-emitting assembly 22 is substantially similar in structure to the light-emitting assembly 12; therefor, the light-emitting assembly 22 still uses the component notations for the light-emitting assembly 12. The main difference between the light-emitting assembly 22 and the light-emitting assembly 12 is that the light-emitting assembly 22 includes a plurality of light-emitting chips 122 disposed in a staggered arrangement on the two opposite sides of the light transmissive substrate 120. Besides, the light-emitting assembly 22 includes two color conversion layers 224 respectively disposed on the two opposite sides of the light transmissive substrate 120 to at least cover every light-emitting chip 122. Thereby, the uniformity of color temperature and the light-emitting uniformity of the light-emitting assembly 22 are improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light source device, comprising:
a reflective cup having an opening, the opening having an opening direction; and
at least one light-emitting assembly disposed inside the reflective cup, the light-emitting assembly comprising:
a light transmissive substrate;
at least one light-emitting chip comprising a first light-emitting surface and a second light-emitting surface, the first light-emitting surface of the light-emitting chip being mounted on the light transmissive substrate in a flip-chip way, the at least one light-emitting chip providing a first light and a second light, the first light being emitted from the first light-emitting surface, the second light being emitted from the second light-emitting surface; and
an electrode circuit disposed on the light transmissive substrate and electrically connected to the at least one light-emitting chip;
wherein the first light emitted from the first light-emitting surface passes through the light transmissive substrate out of the at least one light-emitting assembly to be reflected by the reflective cup to be emitted out of the reflective cup through the opening, and the second light is emitted out of the at least one light-emitting assembly in a direction away from the light transmissive substrate to be reflected by the reflective cup to be emitted out of the reflective cup through the opening.

2. The light source device of claim 1, wherein the at least one light-emitting assembly has a plurality of the light-emitting chips, and the plurality of the light-emitting chips are disposed at a same side of the light transmissive substrate.

3. The light source device of claim 2, wherein the at least one light-emitting assembly further comprises a first cover layer, and the first cover layer comprises color conversion material and covers the second light-emitting surface of the light-emitting chips.

4. The light source device of claim 3, wherein the at least one light-emitting assembly further comprises a second cover layer, and the second cover layer comprises color conversion material and covers a side of the light transmissive substrate where none of the light-emitting chips is disposed.

5. The light source device of claim 4, wherein the first cover layer is thicker than the second cover layer.

6. The light source device of claim 1, wherein the at least one light-emitting assembly has a plurality of the light-emitting chips, the plurality of the light-emitting chips are disposed in a staggered arrangement on two sides of the light transmissive substrate, and the at least one light-emitting assembly further comprises two color conversion layers disposed the two sides respectively of the light transmissive substrate to at least cover every light-emitting chip.

7. The light source device of claim 1, wherein the light transmissive substrate is made of silicon carbide, aluminum oxide, or glass.

8. The light source device of claim 1, wherein the electrode circuit is made of transparent metal oxide or graphene.

9. The light source device of claim 1, further comprising a diffusion cover disposed inside the reflective cup and surrounding the at least one light-emitting assembly, wherein the first light and the second light emitted from the at least one light-emitting chip pass through the diffusion cover and are diffused by the diffusion cover to be reflected by the reflective cup to be emitted out of the reflective cup through the opening.

10. The light source device of claim 1, wherein the first light-emitting surface and the second light-emitting surface of the at least one light-emitting chip are parallel to the opening direction.

11. The light source device of claim 10, wherein the light source device comprises a plurality of the light-emitting assemblies, the plurality of the light-emitting assemblies are arranged in a circular or radial configuration in the reflective cup, and the first light-emitting surface and the second light-emitting surface of the light-emitting chips are parallel to the opening direction.

12. The light source device of claim 10, wherein the light source device comprises two light-emitting assemblies, the two light-emitting assemblies are oppositely disposed inside the reflective cup, and the first light-emitting surface and the second light-emitting surface of the two light-emitting chips are parallel to the opening direction.

13. The light source device of claim 1, wherein an acute angle is formed between the opening direction and the first light-emitting surface or the second light-emitting surface of the at least one light-emitting chip.

14. The light source device of claim 13, wherein the light source device comprises a plurality of the light-emitting assemblies, the plurality of the light-emitting assemblies are arranged in a circular or radial configuration in the reflective cup, and an acute angle is formed between the opening direction and the first light-emitting surface or the second light-emitting surface of the light-emitting chips.

15. The light source device of claim 13, wherein the light source device comprises two light-emitting assemblies, the two light-emitting assemblies are oppositely disposed inside the reflective cup, and an acute angle is formed between the opening direction and the first light-emitting surface or the second light-emitting surface of the two light-emitting chips.
